(19) United States
(12) Patent Application Publication
(10) Pub. No.: US 2015/0370188 A1
(43) Pub. Date: Dec. 24, 2015

(54) TONER FOR DEVELOPING ELECTROSTATIC IMAGE

(71) Applicant: Konica Minolta, Inc., Tokyo (JP)

(72) Inventors: Kaori MATSUSHIMA, Tokyo (JP); Shiro HIRANO, Tokyo (JP); Aya SHIRAI, Tokyo (JP); Kouji SEKIGUCHI, Tokyo (JP); Takaki KAWAMURA, Tokyo (JP); Kazumi IMAE, Kanagawa (JP)

(21) Appl. No.: 14/725,519

(22) Filed: May 29, 2015

(30) Foreign Application Priority Data
Jun. 19, 2014 (JP) 2014-126202

(51) Int. Cl. G03G 9/087

(52) U.S. Cl. CPC G03G 9/08755

(57) ABSTRACT

A toner for developing an electrostatic image includes a toner particle. The toner particle contains a binder resin and a release agent. The binder resin contains an amorphous resin and a crystalline polyester resin. The toner satisfies the following formulae (1) and (2). In the formulae (1) and (2), Tmc (° C.) represents a melting peak temperature derived from the crystalline polyester resin and Tmw (° C.) represents a melting peak temperature derived from the release agent in a heating process in differential scanning calorimetry of the toner.

Tmc>75(° C.) Formula (1)

|Tmw−Tmc|<10(° C.) Formula (2)

### 1. FIELD OF THE INVENTION

The present invention relates to a toner for developing electrostatic images used in electrophotographic image formation.

### 2. DESCRIPTION OF THE RELATED ART

Recently, there has been a demand for an electrophotographic image forming apparatus on reduction in thermal energy in fixing in order to increase a printing speed, reduce an environmental load and so forth.

To meet this demand, it is known that a toner for developing electrostatic images (hereinafter may be simply referred to as a “toner”) used in electrophotographic image formation uses a crystalline resin having excellent sharp meltability, such as crystalline polyester, as a binder resin.

For example, in the case where a crystalline polyester resin and an amorphous resin are mixed to be used as a binder resin, when a temperature exceeds the melting point of the crystalline polyester resin in a temperature history in heat-fixing, the crystalline component melts by heat and becomes compatible with the amorphous resin, which facilitates heat-melting of the amorphous resin and enables fixing at a low temperature. (Refer to, for example, Japanese Patent No. 4962377.)

However, at the same time as the amorphous resin melts by heat, the whole toner is plasticized, so that image storability at a high temperature, to be specific, document offset resistance, cannot be obtained.

In general, into a toner, a release agent is added in order to ensure separability from a fixing member.

A toner passes through a fixing nip part in heat-fixing, and a binder resin in the toner melts by heat, so that the toner is fixed to an image support such as paper. At the time, the binder resin produces viscosity by melting by heat. However, when adhesiveness of the toner to a fixing member is higher than adhesiveness thereof to the image support, or when the toner has low internal cohesive force, the toner moves to the fixing member and accordingly cannot have separability therefrom. In order to ensure separability from the fixing member, the release agent needs to sufficiently ooze out to the surface of the melting toner when the binder resin melts by heat.

### BRIEF SUMMARY OF THE INVENTION

The present invention has been conceived in view of the above circumstances, and objects of the present invention include providing a toner for developing an electrostatic image(s), the toner securing document offset resistance and separability from a fixing member while having low-temperature fixability.

According to an aspect of the present invention, there is provided a toner for developing an electrostatic image, the toner including a toner particle containing a binder resin and a release agent, wherein the binder resin contains an amorphous resin and a crystalline polyester resin, and the toner satisfies the following formulae (1) and (2):

Tmc>75(° C.); and Formula (1)

|Tmw−Tmc|<10(° C.), Formula (2)

wherein Tmc (° C.) represents a melting peak temperature derived from the crystalline polyester resin and Tmw (° C.) represents a melting peak temperature derived from the release agent in a heating process in differential scanning calorimetry of the toner.

In the toner of the present invention, preferably, the Tmc is higher than 80° C.

In the toner of the present invention, preferably, the toner satisfies the following formula (3):

Tmw≧Tmc>Tg, Formula (3)

wherein Tg (° C.) represents a glass transition point of the toner.

In the toner of the present invention, preferably, the release agent is composed of at least an ester-based wax, the release agent is composed of a plurality of carbon chain length components having different carbon chain lengths, and among the carbon chain length components, a content of a carbon chain length component having the largest content in a carbon chain length distribution of the release agent is 70 percent by mass or more.

In the toner of the present invention, far preferably, the content of the carbon chain length component having the largest content is 80 percent by mass or more.

In the toner of the present invention, preferably, the release agent is composed of at least a hydrocarbon-based wax, the release agent is composed of a plurality of carbon chain length components having different carbon chain lengths, and among the carbon chain length components, a content of a carbon chain length component having the largest content in a carbon chain length distribution of the release agent is 5 percent by mass or more.

In the toner of the present invention, far preferably, the content of the carbon chain length component having the largest content is 7 percent by mass or more.

### DETAILED DESCRIPTION OF THE INVENTION

Hereinafter, the present invention is detailed.

### [Toner]

A toner of the present invention is composed of toner particles which contain: a binder resin containing at least an amorphous resin and a crystalline polyester resin; and a release agent. The toner particles may optionally contain other toner constituent components such as a colorant, magnetic powder and a charge control agent. Further, to the toner particles, an external additive(s) such as a fluidizing agent or a cleaning aid may also be added.

The toner of the present invention satisfies the following Formulae (1) and (2):

Tmc>75(° C.); and Formula (1)

|Tmw−Tmc|<10(° C.), Formula (2)

wherein Tmc (° C.) represents a melting peak temperature derived from the crystalline polyester resin and Tmw (° C.) represents a melting peak temperature derived from the release agent in a heating process in differential scanning calorimetry of the toner.

The melting peak temperature Tmc derived from the crystalline polyester resin is higher than 75° C., preferably higher than 80° C. This ensures document offset resistance.

Further, the absolute value of the difference between the melting peak temperature Tmc derived from the crystalline polyester resin and the melting peak temperature Tmw derived from the release agent is less than 10° C., preferably 0° C. or more and less than 5° C. This ensures separability from a fixing member.

As described above, in the toner of the present invention, the binder resin contains the crystalline polyester resin. This facilitates heat-melting of the amorphous resin in heat-fixing, and accordingly allows the toner to have excellent low-temperature fixability fundamentally. Further, the melting peak temperature Tmc derived from the crystalline polyester resin is higher than 75° C. This prevents, even when image supports, such as sheets of paper, having output images thereon are stored at a high temperature (e.g., around 60° C.) in such a way as to be superposed, the image parts from transferring to their facing image supports, and accordingly ensures document offset resistance. Further, the absolute value of the difference between the melting peak temperature Tmc derived from the crystalline polyester resin and the melting peak temperature Tmw derived from the release agent is less than 10° C. This allows, at the time of the toner passing through a fixing nip part, the release agent to melt by heat and wet-spread to between the surface of the melting toner and a fixing member around the time the crystalline polyester resin melts by heat and becomes compatible (mixed) with the amorphous resin and thereby produces viscosity, and accordingly ensures separability from the fixing member. At almost the same as the crystalline polyester resin melts by heat, the whole binder resin softens. This facilitates oozing-out of the release agent to the surface of the melting toner.

The melting peak temperature Tmc derived from the crystalline polyester resin and the melting peak temperature Tmw derived from the release agent are values determined in the heating process in the differential scanning calorimetry of the toner. More specifically, they are measurable with a differential scanning calorimeter DSC-7 (from PerkinElmer Inc.) and a thermal analysis controller TAC7/DX (from PerkinElmer Inc.).

The measurement procedure is as follows; precisely weight 4.5 mg to 5.0 mg of the toner to the second decimal place; enclose the weighted toner in an aluminum pan (KIT NO. 0219-0041); set the aluminum pan on a sample holder of the DSC-7; perform temperature control of Heat-Cool-Heat with measurement conditions of a measurement temperature of 0° C. to 200° C., a temperature rising rate of 10° C./min and a temperature falling rate of 10° C./min; and make an analysis on the basis of data obtained in the 2^{nd} Heat. As a reference, an empty aluminum pan is used. The melting peak temperature is a temperature of the peak top.

The toner of the present invention preferably satisfies the following Formula (3):

Tmw≧Tmc>Tg, Formula (3)

wherein Tg (° C.) represents a glass transition point of the toner.

The melting peak temperature Tmc derived from the crystalline polyester resin is higher than the glass transition point Tg of the toner. This further ensures document offset resistance. Further, the melting peak temperature Tmc derived from the crystalline polyester resin is equal to or lower than the melting peak temperature Tmw derived from the release agent, so that when the toner is heated at the fixing nip part and accordingly the temperature thereof increases, the crystalline polyester resin melts by absorbing the heat and becomes compatible (mixed) with the amorphous resin, whereby the toner is fixed. The melting peak temperature derived from the release agent is equal to or higher than the melting peak temperature derived from the crystalline polyester resin, so that thermal energy conducted from the fixing member is first used by the crystalline polyester resin to melt. Thus, melting of the crystalline polyester resin is not inhibited, and accordingly fixing at a low temperature is feasible.

The glass transition point Tg of the toner is a value determined as follows.

In the differential scanning calorimetry of the toner, an extension of a baseline before rising of the first melting peak and a tangent indicating the maximum inclination between the rising part of the first melting peak and the peak top are drawn, and the intersection point thereof is taken as the glass transition point Tg.

### [Binder Resin]

In the toner of the present invention, the binder resin contains at least an amorphous resin and a crystalline polyester resin. The polyester resin means both a polyester resin composed of a polyester polymerization segment only and a modified resin composed of the polyester polymerization segment and another component mixed therewith at a ratio of 50 percent by mass or less. As the component mixed with the polyester polymerization segment, a vinyl-based polymerization segment is preferably used.

### [Amorphous Resin]

The amorphous resin, which constitutes the binder resin, is contained in the binder resin as a main component. The amorphous resin is not particularly limited, and examples which are preferable in terms of low-temperature fixability, heat-resistant storability of the toner and heat resistance of fixed images include: vinyl resins such as a styrene resin, an acrylic resin and a styrene-acrylic copolymer resin; and an amorphous polyester resin. Usable examples of the amorphous resin also include: vinyl resins other than the above ones such as an olefin-based resin; a polyamide-based resin; a polycarbonate resin; a polyether resin; a polyvinyl acetate resin; a polysulfone resin; an epoxy resin; a polyurethane resin; and a urea resin.

As the amorphous resin, the above resins can be used individually (one type) or in combination (two or more types).

A monomer(s) for producing a vinyl resin such as a styrene resin, an acrylic resin or a styrene-acrylic copolymer resin is exemplified by a vinyl monomer(s).

As the vinyl monomer, the following ones can be used. As the vinyl monomer, the following monomers can be used individually (one type) or in combination (two or more types).

### (1) Styrene-Based Monomers

styrene, o-methylstyrene, m-methylstyrene, p-methylstyrene, α-methylstyrene, p-phenylstyrene, p-ethylstyrene, 2,4-dimethylstyrene, p-tert-butylstyrene, p-n-hexylstyrene, p-n-octylstyrene, p-n-nonylstyrene, p-n-decylstyrene, p-n-dodecylstyrene, derivatives thereof, etc.

### (2) Methacrylate-Based Monomers

methyl methacrylate, etyl methacrylate, n-butyl methacrylate, isopropyl methacrylate, isobutyl methacrylate, t-butyl methacrylate, n-octyl methacrylate, 2-ethylhexyl methacrylate, stearyl methacrylate, lauryl methacrylate, phenyl methacrylate, diethylaminoethyl methacrylate, dimethylaminoethyl methacrylate, derivatives thereof, etc.

### (3) Vinyl Esters

vinyl propionate, vinyl acetate, vinyl benzoate, etc.

### (4) Vinyl Ethers

methyl vinyl ether, ethyl vinyl ether, etc.

### (5) Vinyl Ketones

methyl vinyl ketone, ethyl vinyl ketone, hexyl vinyl ketone, etc.

### (6)N-Vinyl Compounds

N-vinylcarbazole, N-vinylindole, N-vinylpyrrolidone, etc.

### (7) Others

vinyl compounds such as vinylnaphthalene and vinylpyridine; acrylic or methacrylic acid derivatives such as acrylonitrile, methacrylonitrile and acrylamide; etc.

As the vinyl monomer, a vinyl monomer having an ionic dissociation group such as a carboxy group, a sulfonic acid group or a phosphoric acid group is preferably used. To be specific, the following ones are examples thereof.

Examples of the monomer having a carboxy group include acrylic acid, methacrylic acid, maleic acid, itaconic acid, cinnamic acid, fumaric acid, monoalkyl maleate ester, and monoalkyl itaconate ester. Examples of the monomer having a sulfonic acid group include styrene sulfonate, allyl sulfosuccinate, and 2-acrylamide-2-methylpropane sulfonate. Examples of the monomer having a phosphoric acid group include acid phosphoxyethyl methacrylate.

Moreover, it is also possible to use, as the vinyl monomer, a vinyl resin having a crosslinking structure prepared by using a polyfunctional vinyl. Examples of the polyfunctional vinyl include divinylbenzene, ethylene glycol dimethacrylate, ethylene glycol diacrylate, diethylene glycol dimethacrylate, diethylene glycol diacrylate, triethylene glycol dimethacrylate, triethylene glycol diacrylate, neopentyl glycol dimethacrylate, and neopentyl glycol diacrylate.

The amorphous polyester resin means, among publically-known polyester resins produced by polycondensation reaction of di- or higher-valent-carboxylic acid (polycarboxylic acid) and di- or higher-valent-hydric alcohol (polyhydric alcohol), those showing no clear melting peak in differential scanning calorimetry (DSC). The clear melting peak means, to be specific, a peak having a full width at half maximum of the melting peak of 15° C. or less measured at a temperature rising rate of 10° C./min in differential scanning calorimetry (DSC).

The polycarboxylic acid is a compound containing two or more carboxy groups in one molecule.

Examples of the polycarboxylic acid for producing the amorphous polyester resin include: saturated aliphatic dicarboxylic acids such as oxalic acid, malonic acid, succinic acid, glutaric acid, adipic acid, pimelic acid, suberic acid, azelaic acid, sebacic acid, 1,9-nonanedicarboxylic acid, 1,10-decanedicarboxylic acid, 1,11-undecanedicarboxylic acid, 1,12-dodecanedicarboxylic acid, 1,13-tridecanedicarboxylic acid, 1,14-tetradecanedicarboxylic acid, 1,16-hexadecanedicarboxylic acid, and 1,18-octadecanedicarboxylic acid; aromatic dicarboxylic acids such as phthalic acid, isophthalic acid, terephthalic acid, and naphthalenedicarboxylic acid; unsaturated aliphatic dicarboxylic acids such as maleic acid, fumaric acid, itaconic acid, citraconic acid, glutaconic acid, isododecenyl succinic acid, n-dodecenyl succinic acid and n-octenyl succinic acid; and tri- or higher-valent-carboxylic acids such as trimellitic acid, pyromellitic acid, naphthalenetricarboxylic acid, naphthalenetetracarboxylic acid, pyrenetricarboxylic acid, and pyrenetetracarboxylic acid.

These may be used individually (one type) or in combination (two or more types).

The polyhydric alcohol is a compound containing two or more hydroxy groups in one molecule.

Examples of the polyhydric alcohol for producing the amorphous polyester resin include: aliphatic diols such as ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,20-eicosanediol; bisphenols such as bisphenol A and bisphenol F and alkylene oxide adducts of these bisphenols such as ethylene oxide adducts and propylene oxide adducts tereof; and tri- or higher-valet-hydric alcohols such as glycerin, pentaerythritol, hexamethylolmelamine, hexaethylolmelamine, tetramethylolbenzoguanamine, and tetraethylolbenzoguanamine.

These may be used individually (one type) or in combination (two or more types).

The glass transition point of the amorphous resin is preferably 20 to 65° C. and far preferably 30 to 63° C.

The glass transition point of the amorphous resin being in the above range ensures low-temperature fixability.

In the present invention, the glass transition point of the amorphous resin is a value determined with Diamond DSC (from PerkinElmer Inc.).

The measurement procedure of the glass transition point thereof is as follows: enclose 3.0 mg of a measurement sample (amorphous resin) in an aluminum pan; set the aluminum pan on a holder; perform temperature control of Heat-Cool-Heat with measurement conditions of a measurement temperature of 0° C. to 200° C., a temperature rising rate of 10° C./min and a temperature falling rate of 10° C./min; make an analysis on the basis of data obtained in the 2^{nd} Heat; draw an extension of a baseline before rising of the first melting peak and a tangent indicating the maximum inclination between the rising part of the first melting peak and the peak top; and takes the intersection point thereof as the glass transition point. As a reference, an empty aluminum pan is used.

The softening point of the amorphous resin is preferably 80 to 120° C. and far preferably 90 to 110° C. in order that the toner has low-temperature fixability.

In the present invention, the softening point of the amorphous resin is a value determined with a flow tester.

The measurement procedure of the softening point thereof is as follows: place and flatten out 1.1 g of a measurement target (amorphous resin) in a Schale (petri dish) under the environment of 20° C. and 50% RH; leave the measurement target for 12 hours or more; apply a pressure of 3,820 kg/cm² to the measurement target for 30 seconds with a molding machine SSP-10A (from Shimadzu Corporation) so as to produce a cylindrical molded sample having a diameter of 1 cm; with a flow tester CFT-500D (from Shimadzu Corporation), extrude the molded sample from a hole (1 mm in diameter×1 mm) of a cylindrical die with a piston having a diameter of 1 cm from the end of preheating with conditions of an applied load of 196 N (20 kgf), an initial temperature of 60° C., a preheating time of 300 seconds and a temperature rising rate of 6° C./min under the environment of 24° C. and 50% RH; and take, as the softening point, an offset method temperature T_{offset} measured by a method for measuring a melting point while increasing a temperature, setting an offset value at 5 mm.

The molecular weight of the amorphous resin measured by Gel Permeation Chromatography (GPC) is preferably 10,000 to 50,000 and far preferably 25,000 to 35,000 in weight average molecular weight (Mw), and preferably 5,000 to 20,000 and far preferably 6,500 to 12,000 in number average molecular weight (Mn).

The molecular weight of the amorphous resin being in the above ranges ensures low-temperature fixability and separability from a fixing member.

When the molecular weight of the amorphous resin is too heavy, low-temperature fixability may be unable to obtain, whereas when the molecular weight of the amorphous resin is too light, separability from a fixing member may be unable to obtain.

In the present invention, the molecular weight of the amorphous resin measured by Gel Permeation Chromatography (GPC) is a value determined as follows.

The details are as follows. A device HLC-8220 (from Tosoh Co.) and a column TSKguardcolumn+TSKgel SuperHZM-M 3 ren (from Tosoh Co.) are used. While a column temperature is kept at 40° C., tetrahydrofuran (THF) as a carrier solvent is made to flow at a flow velocity of 0.2 mL/min. A measurement sample (amorphous resin) is treated with an ultrasonic disperser for five minutes at room temperature to be dissolved in the tetrahydrofuran so as to be a concentration of 1 mg/mL. Next, the resulting product is treated with a membrane filter having a pore size of 0.2 um so as to produce a sample solution, and 10 μL of the sample solution is poured into the device together with the above carrier solvent, the refractive index thereof is detected with a refractive index detector (RI detector), and the molecular weight distribution of the measurement sample is calculated using a calibration curve measured with monodisperse polystyrene standard particles. Ten pieces of polystyrene are used for measuring the calibration curve.

The content ratio of the amorphous resin in the binder resin is preferably 70 to 99 percent by mass.

The content ratio of the amorphous resin being in the above range ensures sufficient low-temperature fixability, sufficient heat-resistant storability of the toner and heat resistance of fixed images, when the amorphous resin is used together with the crystalline polyester resin as the binder resin.

### (Crystalline Polyester Resin)

The crystalline polyester resin of the binder resin means, among publically-known polyester resins produced by polycondensation reaction of di- or higher-valent-carboxylic acid (polycarboxylic acid) and di- or higher-valent-hydric alcohol (polyhydric alcohol), those not showing stepwise endothermic change but having a clear melting peak in differential scanning calorimetry (DSC). The clear melting peak means, to be specific, a peak having a full width at half maximum of the melting peak of 15° C. or less measured at a temperature rising rate of 10° C./min in differential scanning calorimetry (DSC).

Examples of the polycarboxylic acid for producing the crystalline polyester resin include: saturated aliphatic dicarboxylic acids such as succinic acid; cycloaliphatic dicarboxylic acids such as cyclohexanedicarboxylic acid; aromatic dicarboxylic acids such as phthalic acid, isophthalic acid and terephthalic acid; tri- or higher-valent-carboxylic acids such as trimellitic acid and pyromellitic acid; and anhydrides and C₁-C₃ alkyl esters of these carboxylic acid compounds.

These may be used individually (one type) or in combination (two or more types).

Examples of the polyhydric alcohol for producing the crystalline polyester resin include: aliphatic diols such as 1,2-propanediol, 1,3-propanediol, 1,4-butanediol, 1,5-pentanediol, 1,6-hexanediol, 1,7-heptanediol, 1,8-octanediol, neopentyl glycol, and 1,4-butenediol; and tri- or higher-valent-hydric alcohols such as glycerin, pentaerythritol, trimethylolpropane, and sorbitol.

These may be used individually (one type) or in combination (two or more types).

The melting point of the crystalline polyester resin is higher than 75° C., preferably higher than 80° C.

The melting point of the crystalline polyester resin being in the above range ensures sufficient low-temperature fixability and excellent document offset resistance.

The melting point of the crystalline polyester resin is a value determined as follows.

The melting point (Tm) of the crystalline polyester resin is a temperature of the top of the melting peak and measured by DSC, namely, differential scanning calorimetry, with Diamond DSC (from PerkinElmer Inc.).

More specifically, the measurement of the melting point thereof is performed as follows: enclose 1.0 mg of a measurement sample (crystalline polyester resin) in an aluminum pan (KIT NO. B0143013); set the aluminum pan on a sample holder of the Diamond DSC; perform temperature control of Heat-Cool-Heat with measurement conditions of a measurement temperature of 0° C. to 200° C., a temperature rising rate of 10° C./min and a temperature falling rate of 10° C./min; and make an analysis on the basis of data obtained in the 2ⁿd Heat.

The molecular weight of the crystalline polyester resin measured by Gel Permeation Chromatography (GPC) is preferably 12,000 to 30,000 in weight average molecular weight (Mw), and preferably 3,000 to 10,000 in number average molecular weight (Mn).

The molecular weight of the crystalline polyester resin measured by Gel Permeation Chromatography (GPC) is measured in the same way as the above except that the crystalline polyester resin is used as a measurement sample.

The content ratio of the crystalline polyester resin in the binder resin is preferably 5 to 30 percent by mass and far preferably 10 to 20 percent by mass.

When the content ratio of the crystalline polyester resin is in the above range, the amount of the crystalline polyester resin enough for the toner to have low-temperature fixability can be introduced into the toner particles.

When the content ratio of the crystalline polyester resin is too small, sufficient low-temperature fixability may be unable to obtain, whereas when the content ratio of the crystalline polyester resin is too large, separability from a fixing member may be difficult to obtain.

### [Release Agent]

The toner of the present invention contains a release agent to secure separability from a fixing member.

As the release agent, an ester-based wax or a hydrocarbon-based wax can be used. These waxes may be synthesized waxes or purified commercially-available waxes. The purifying method is exemplified by a method of dissolving a commercially-available wax in n-hexane, heptane or the like to re-crystalize. These release agents may be used individually (one type) or in combination (two or more types).

Examples of the ester-based wax include carnauba wax, montan wax, behenic acid behenate, trimethylolpropane tribehenate, pentaerythritol tetrabehenate, pentaerythritol diacetate dibehenate, glycerin tribehenate, 1,18-octadecanediol distearate, trimellitic acid tristearyl, and distearyl maleate.

Examples of the hydrocarbon-based wax include: polyolefin waxes such as polyethylene wax and polypropylene wax; paraffin wax derived from oil; microcrystalline wax; and Fischer Tropsch wax and polyethylene wax as synthetic waxes.

The ester-based wax or hydrocarbon-based wax of the release agent is composed of a plurality of carbon chain length components having different carbon chain lengths. In the case of the release agent composed of the ester-based wax, the content [Cm] of a carbon chain length component having the largest content is preferably 70 percent by mass or more and far preferably 80 percent by mass or more, whereas in the case of the release agent composed of the hydrocarbon-based wax, the content [Cm] of a carbon chain length component having the largest content is preferably 5 percent by mass or more and far preferably 7 percent by mass or more, in a carbon chain length distribution of the release agent.

The content [Cm] of a carbon chain length component having the largest content in the release agent being in the above range ensures sufficient image storability at a high temperature and document offset resistance.

The carbon chain length distribution of the release agent indicates variation in total carbon numbers (carbon chain lengths) of chain-type (non-cyclic) alkyl skeletons of esters or paraffins which constitute the release agent. The total carbon number is: the sum of the number of carbons of fatty acid and the number of carbons of aliphatic alcohol in the case of the ester-based wax; and the number of carbons of alkane in the case of the hydrocarbon-based wax.

The content [Cm] of a carbon chain length component having the largest content in the release agent can be controlled, in the case of the release agent composed of the ester-based wax, by using, as a starting material, a wax having a carbon chain length distribution which shows monodisperse or by refining a commercially-available wax, and in the case of the release agent composed of the hydrocarbon-based wax, by refining a commercially-available wax.

In the present invention, the carbon chain length distribution of the release agent is measured by Gel Permeation Chromatography (GPC).

More specifically, the carbon chain length distribution thereof is measured with the conditions below.

### —Measurement Conditions—

After a measurement sample (release agent) is dissolved in o-dichlorobenzene the temperature of which is 145° C., the measurement sample is filtered with a sintered filter having a pore diameter of 1.0 μm.

GPC Device: HLC-8121GPC/HT (from Tosoh Co.)

Column: TSKgelG2000HHR(20)HT (inner diameter of 7.8 mm×30 cm) 3 ren (from Tosoh Co.)

Column Temperature: 140° C.

Solvent: o-dichlorobenzene

Flow Velocity: 1.0 ml/min

Sample Concentration: 0.1%(v/w)

Injection Amount of Sample: 500 μl

Detector: refractive index detector (RI detector)

Calibration Curve: standard polystyrene, n-hexylbenzene

The detection level with the above column is 10,000 in terms of polystyrene.

The melting point of the release agent is preferably 65 to 90° C. and far preferably 65 to 85° C.

When the melting point of the release agent is too low, poor images may be formed, whereas when the melting point of the release agent is too high, separability from a fixing member may be difficult to obtain.

The melting point of the release agent is a value determined with Diamond DSC (from PerkinElmer Inc.).

The measurement procedure of the melting point thereof is as follows: enclose 3.0 mg of a measurement sample (release agent) in an aluminum pan; set the aluminum pan on a holder; perform temperature control of Heat-Cool-Heat with measurement conditions of a measurement temperature of 0° C. to 200° C., a temperature rising rate of 10° C./min and a temperature falling rate of 10° C./min; make an analysis on the basis of data obtained in the 2^{nd} Heat; and take the top of the melting peak derived from the release agent as the melting point. As a reference, an empty aluminum pan is used.

The content ratio of the release agent in the toner particles is preferably 1 to 20 percent by mass and far preferably 5 to 20 percent by mass. The content ratio of the release agent in the toner particles being in the above range ensures both separability from a fixing member and low-temperature fixability.

In the toner of the present invention, the structure of the toner particles is not limited, and examples thereof include a single-layer structure, a core-shell structure, a multilayer structure and a domain-matrix structure. In particular, a core-shell structure is preferable in order to ensure heat-resistant storability.

The shell layer may completely cover the core particles or partially expose the surface of the core particles.

A resin which constitutes the shell layer is not particularly limited, but a crystalline polyester resin and a vinyl resin are preferable.

The thickness of the shell layer is preferably 0.1 to 1 μm.

In the present invention, the thickness of the shell layer is a value determined from an image observed under a transmission electron microscope (TEM).

The content ratio of the resin, which constitutes the shell layer, in the toner particles is preferably 5 to 30 percent by mass.

### [Colorant]

In the case where the toner particles contain a colorant, publically-known various colorants such as carbon black, black iron oxide, dyes and pigments can be used as the colorant.

Examples of the carbon black include channel black, furnace black, acetylene black, thermal black and lamp black, and examples of the black iron oxide include magnetite, hematite and titanium(III) oxide.

Examples of the dyes include: C.I. Solvent Reds 1, 49, 52, 58, 63, 111 and 122; C.I. Solvent Yellows 19, 44, 77, 79, 81, 82, 93, 98, 103, 104, 112 and 162; C.I. Solvent Blues 25, 36, 60, 70, 93 and 95.

Examples of the pigments include: C.I. Pigment Reds 5, 48:1, 48:3, 53:1, 57:1, 81:4, 122, 139, 144, 149, 150, 166, 177, 178, 222, 238 and 269; C.I. Pigment Oranges 31 and 43; C.I. Pigment Yellows 14, 17, 74, 93, 94, 138, 155, 156, 158, 180 and 185; C.I. Pigment Green 7; and C.I. Pigment Blues 15:3 and 60.

With respect to each of colors, the colorant for producing a toner of a color, the above ones for the toner of the color can be used individually (one type) or in combination (two or more types).

The content ratio of the colorant in the toner particles is preferably 1 to 10 percent by mass and far preferably 2 to 8 percent by mass. When the content of the colorant is too small, the toner to be produced may be unable to have desired tinting strength, whereas when the content of the colorant is too large, the colorant may be free or adhere to carriers or the like, which may affect charge characteristics.

### [Charge Control Agent]

In the case where the toner particles contain a charge control agent, publically-known various compounds can be used as the charge control agent.

The content ratio of the charge control agent in the toner particles is preferably 0.1 to 10 percent by mass and far preferably 1 to 5 percent by mass.

### [External Additive]

In the toner of the present invention, the toner particles may be used as they are as the toner, but, in order to improve fluidity, charge characteristics, cleanability and so forth, an external additive(s) such as a fluidizing agent or a cleaning aid may be added to the toner particles.

As the external additive, various ones may be used in combination.

The content ratio of the external additive, namely, the total added amount of the external additive(s), is, to 100 parts by mass of the toner particles, preferably 0.05 to 5 parts by mass and far preferably 0.1 to 3 parts by mass.

### [Particle Diameter of Toner]

In the toner of the present invention, the average particle diameter is, for example, preferably 3 to 10 μm and far preferably 5 to 8 μm in volume-based median diameter. This average particle diameter is controllable with the concentration of a flocculant, the added amount of an organic solvent, the fusion time, the composition of the binder resin and so forth used in producing the toner.

The volume-based median diameter being in the above range can reproduce microdot images at the 1200 dpi level with a high degree of fidelity.

The volume-based median diameter of the toner is measured and calculated with a measuring device constituted of Multisizer 3 (from Beckman Coulter, Inc.) connected with a computer system equipped with data processing software Software V3.51. The measurement and calculation are performed as follows: add and well disperse 0.02 g of a measurement sample (toner) into 20 mL of a surfactant solution (e.g., a surfactant solution composed of a surfactant component-containing neutral detergent diluted 10 times with pure water for dispersing toner particles) and then perform ultrasonic dispersion for one minute so as to prepare a toner dispersion; pour this toner dispersion into a beaker containing ISOTON II (from Beckman Coulter, Inc.) in a sample stand with a pipette until the displayed concentration of the measuring device reaches 8%; set a measurement particle counting number and an aperture diameter in the measuring device at 25,000 and 100 um, respectively; calculate frequency values with a range of 2 to 60 um as a measurement range divided into 256 segments; and take the particle diameter at 50% in volume-based cumulative fractions from the largest as the volume-based median diameter.

### [Average Circularity of Toner]

In the toner of the present invention, the average circularity of the toner particles of the toner is preferably 0.930 to 1.000 and far preferably 0.950 to 0.995 in terms of stability of charge characteristics and low-temperature fixability.

When the average circularity is in the above range, the toner particles are difficult to be crushed, and a friction charge application member is prevented from being dirty and accordingly charge characteristics of the toner become stable, and also quality of formed images becomes high.

The average circularity of the toner is a value determined with FPIA-2100 (from Sysmex Co.). More specifically, the average circularity thereof is measured as follows: wet a measurement sample (toner) with a surfactant-containing solution; perform ultrasonic dispersion for one minute; after the dispersion, take pictures with the FPIA-2100 (from Sysmex Co.) in an HPF (High Power Field, high magnification imaging) mode at a proper concentration of a HPF detection number of 3,000 to 10,000 particles as a measurement condition; calculate the circularity of each toner particle by the following Formula (y); add up values of the circularity of the toner particles and divides the sum thereof by the number of toner particles. When the HPE detection number is in the above range, reproducibility is obtained.

Formula (y): Circularity=(Circumference of Circle Having Projected Area the Same as Projected Area of Particle Image)/Perimeter of Projected Particle Image

### [Developer]

The toner of the present invention may be used as a magnetic or nonmagnetic one-component developer or as a two-component developer composed of the toner mixed with carriers. In the case where the toner is used as a two-component developer, the carriers may be magnetic particles of a publically-known material. Examples thereof include: metals such as iron, ferrite and magnetite; and alloys of these metals with other metals such as aluminum and lead. In particular, ferrite particles are preferable. Further, the carriers may be coated carriers composed of magnetic particles the surface of which is coated with a coating agent such as a resin, or may be binder carriers composed of magnetic powder dispersed in a binder resin.

The volume-based median diameter of the carriers is preferably 20 pm to 100 pm and far preferably 25 μm to 80 μm. The volume-based median diameter of the carriers is measurable, for example, with a laser diffraction particle size analyzer HELOS (from Sympatec Inc.) provided with a wet-type disperser.

According to the toner for developing electrostatic images of the present invention, the melting peak temperature Tmc derived from the crystalline polyester resin and the melting peak temperature Tmw derived from the release agent satisfy Formulae (1) and (2). Consequently, the toner secures document offset resistance and separability from a fixing member while having low-temperature fixability.

### [Method for Producing Toner]

A method for producing the toner of the present invention is not particularly limited, and examples thereof include pulverization, emulsion dispersion, suspension polymerization, dispersion polymerization, emulsion polymerization, emulsion polymerization agglomeration and other publically-known methods. In particular, emulsion polymerization agglomeration is preferable in terms of producing costs and stability in producing.

The method for producing the toner of the present invention employing emulsion polymerization agglomeration is a method of mixing an aqueous dispersion composed of particles of a binder resin (hereinafter may be referred to as “binder resin particles”) dispersed in an aqueous medium with an aqueous dispersion composed of particles of a colorant (hereinafter may be referred to as “colorant particles”) dispersed in an aqueous medium and agglomerating and fusing the binder resin particles and colorant particles so as to form toner particles.

The binder resin particles may have a multilayer structure of two or more layers composed of binder resins having different compositions. The binder resin particles having this structure, for example, a two-layer structure, can be produced by: adjusting a dispersion of resin particles by polymerization (first stage polymerization) according to a normal method; adding a polymerization initiator and a polymerizable monomer(s) to the dispersion; and subjecting this system to polymerization (second stage polymerization).

The aqueous dispersion means a dispersion composed of a dispersion body (particles) dispersed in an aqueous medium, and the aqueous medium means a medium containing water as a main component (50 percent by mass or more). Components other than water include an organic solvent dissoluble in water, and examples thereof include methanol, ethanol, isopropanol, butanol, acetone, methyl ethyl ketone, and tetrahydrofuran. Among these, alcohol-based organic solvents which do not dissolve resin, such as methanol, ethanol, isopropanol and butanol, are particularly preferable.

An example of the emulsion polymerization agglomeration employed as the method for producing the toner of the present invention includes the following steps:

(a) a step of preparing an aqueous dispersion composed of particles of an amorphous resin (hereinafter may be referred to as “amorphous resin particles”) dispersed in an aqueous medium;

(b) a step of preparing an aqueous dispersion composed of particles of a crystalline polyester resin (hereinafter may be referred to as “crystalline polyester resin particles”) dispersed in an aqueous medium;

(c) a step of preparing an aqueous dispersion composed of colorant particles dispersed in an aqueous medium;

(d) a step of agglomerating and fusing the amorphous resin particles, the crystalline polyester resin particles and the colorant particles in the aqueous medium so as to form associated particles;

(e) a step of aging the associated particles by thermal energy so as to control the shape thereof and thereby produce toner particles;

(f) a step of cooling the dispersion of the toner particles;

(g) a step of filtering the dispersion of the toner particles so as to separate the toner particles and the aqueous medium and removing a surfactant and so forth from the toner particles; and

(h) a step of drying the washed toner particles; and, as needed

(i) a step of adding an external additive to the dried toner particles.

### (a) Preparing Step of Aqueous Dispersion of Amorphous Resin Particles

At this step, an aqueous dispersion of amorphous resin particles of an amorphous resin is prepared.

In the case where the amorphous resin is, for example, a vinyl resin such as a styrene-acrylic copolymer resin, the aqueous dispersion of amorphous resin particles can be prepared by mini-emulsion polymerization with a vinyl monomer(s) to produce the amorphous resin. That is, for example, the vinyl monomer is added to an aqueous medium containing a surfactant, and mechanical energy is applied thereto so as to form liquid droplets, and then polymerization reaction proceeds in the liquid droplets by the radical of a water-soluble radical polymerization initiator. The liquid droplets may contain an oil-soluble polymerization initiator.

### [Surfactant]

Usable examples of the surfactant used at this step include publically-known various anionic surfactants, cationic surfactants and nonionic surfactants.

### [Polymerization Initiator]

Usable examples of the polymerization initiator used at this step include publically-known various polymerization initiators, and for example, persulfate (potassium persulfate, ammonium persulfate, etc.) is preferably used. Other than that, an azo-based compound (4,4′-azobis(4-cyanovaleric acid), salt thereof, 2,2′-azobis(2-amidinopropane) salt, etc.), a peroxide compound, azobisisobutyronitrile and so forth may be used.

### [Chain Transfer Agent]

At this step, in order to adjust the molecular weight of the amorphous resin, a general-use chain transfer agent can be used. The chain transfer agent is not particularly limited, and examples thereof include: 2-chloroethanol; mercaptan such as octyl mercaptan, dodecyl mercaptan, and t-dodecyl mercaptan; and styrene dimer.

In the case where the amorphous resin is, for example, an amorphous polyester resin, an aqueous dispersion of amorphous resin particles can be prepared by synthesizing the amorphous polyester resin and dispersing the amorphous polyester resin in an aqueous medium in the shape of particles. More specifically, the aqueous dispersion of amorphous resin particles can be prepared by: dissolving or dispersing the amorphous polyester resin in an organic solvent so as to prepare an oil phase solution; dispersing the oil phase solution in an aqueous medium by phase-transfer emulsification so as to form oil droplets the particle diameter of which is controlled to be a desired particle diameter; and then removing the organic solvent.

The used amount of the aqueous medium is, to 100 parts by mass of the oil phase solution, preferably 50 to 2,000 parts by mass and far preferably 100 to 1,000 parts by mass.

Into the aqueous medium, a surfactant and so forth may be added in order to improve dispersion stability of the oil droplets. Examples of the surfactant can be the same as those cited above.

As the organic solvent used in preparing the oil phase solution, an organic solvent having a low boiling point and low dissolubility in water is preferable because removal thereof after formation of the oil droplets is easy, and examples thereof include methyl acetate, ethyl acetate, methyl ethyl ketone, methyl isobutyl ketone, toluene, and xylene. These may be used individually (one type) or in combination (two or more types). The used amount of the organic solvent is, to 100 parts by mass of the amorphous polyester resin, usually 1 to 300 parts by mass.

Emulsion dispersion of the oil phase solution can be performed by utilizing mechanical energy.

Toner particles of the present invention contain a release agent. This release agent can be introduced into the toner particles at this step, for example, by dissolving or dispersing the release agent in advance in the solution of the vinyl monomer (or the oil phase solution of the amorphous polyester resin) to produce the amorphous resin.

The release agent can also be introduced into the toner particles by separately preparing a dispersion of release agent particles composed of only the release agent and agglomerating the release agent particles together with the amorphous resin particles, the crystalline polyester resin particles and the colorant particles at the agglomerating-fusing step. However, it is preferable to adopt the method of introducing the release agent into the toner particles in advance at this step.

The toner particles of the present invention may contain, as needed, another internal additive such as a charge control agent. This internal additive can be introduced into the toner particles at this step, for example, by dissolving or dispersing the internal additive in advance in the solution of the vinyl monomer (or the oil phase solution of the amorphous polyester resin) to produce the amorphous resin.

The internal additive can also be introduced into the toner particles by separately preparing a dispersion of internal additive particles composed of only the internal additive and agglomerating the internal additive particles together with the amorphous resin particles, the crystalline polyester resin particles and the colorant particles at the agglomerating-fusing step. However, it is preferable to adopt the method of introducing the internal additive into the toner particles in advance at this step.

The average particle diameter of the amorphous resin particles is preferably 100 to 400 nm in volume-based median diameter.

In the present invention, the volume-based median diameter of the amorphous resin particles is a value determined with Microtrac UPA-150 (from Nikkiso Co., Ltd.).

### (b) Preparing Step of Aqueous Dispersion of Crystalline Polyester Resin Particles

At this step, an aqueous dispersion of crystalline polyester resin particles of a crystalline polyester resin is prepared.

The aqueous dispersion of crystalline polyester resin particles can be prepared by synthesizing the crystalline polyester resin and dispersing the crystalline polyester resin in an aqueous medium in the shape of particles. More specifically, the aqueous dispersion of amorphous resin particles can be prepared by: dissolving or dispersing the crystalline polyester resin in an organic solvent so as to prepare an oil phase solution; dispersing the oil phase solution in an aqueous medium by phase-transfer emulsification so as to form oil droplets the particle diameter of which is controlled to be a desired particle diameter; and then removing the organic solvent.

The used amount of the aqueous medium is, to 100 parts by mass of the oil phase solution, preferably 50 to 2,000 parts by mass and far preferably 100 to 1,000 parts by mass.

Into the aqueous medium, a surfactant and so forth may be added in order to improve dispersion stability of the oil droplets. Examples of the surfactant can be the same as those cited at the above step.

As the organic solvent used in preparing the oil phase solution, an organic solvent having a low boiling point and low dissolubility in water is preferable because removal thereof after formation of the oil droplets is easy, and examples thereof include methyl acetate, ethyl acetate, methyl ethyl ketone, methyl isobutyl ketone, toluene, and xylene. These may be used individually (one type) or in combination (two or more types). The used amount of the organic solvent is, to 100 parts by mass of the amorphous polyester resin, usually 1 to 300 parts by mass.

Emulsion dispersion of the oil phase solution can be performed by utilizing mechanical energy.

The average particle diameter of the crystalline polyester resin particles is preferably 100 to 400 nm in volume-based median diameter.

In the present invention, the volume-based median diameter of the crystalline polyester resin particles is a value determined with Microtrac UPA-150 (from Nikkiso Co., Ltd.).

### (c) Preparing Step of Aqueous Dispersion of Colorant Particles

This step is an optional step performed when toner particles are desired to contain a colorant. At this step, an aqueous dispersion of colorant particles is prepared by dispersing a colorant in an aqueous medium in the shape of particles.

The aqueous dispersion of colorant particles can be prepared by dispersing a colorant in an aqueous medium into which a surfactant is added at a critical micelle concentration (CMC) or more.

The colorant can be dispersed by utilizing mechanical energy. A disperser to use is not particularly limited and, preferable examples thereof include: pressure-type dispersers such as an ultrasonic disperser, a mechanical homogenizer, a manton gaulin homogenizer and a pressure-type homogenizer; and media-type dispersers such as a sand grinder, a getsman mill and a diamond fine mill.

The volume-based median diameter of the colorant particles in the dispersed state is preferably 10 to 300 nm, far preferably 100 to 200 nm and particularly preferably 100 to 150 nm.

In the present invention, the volume-based median diameter of the colorant particles is a value determined with an electrophoretic light scattering photometer ELS-800 (from Otsuka Electronics Co., Ltd).

### (d) Agglomerating-Fusing Step

At this step, the amorphous resin particles, the crystalline polyester resin particles and the colorant particles and optionally together with particles of other toner constituent components are agglomerated and heated to be fused.

More specifically, the above particles are agglomerated and fused by: adding a fluocculant into the (mixed) aqueous dispersion of the above particles dispersed in the (mixed) aqueous medium at a critical agglomeration concentration or more; and increasing the temperature to the glass transition point of the amorphous resin or higher.

The fusing temperature to fuse the amorphous resin particles and the crystalline polyester resin particles needs to be equal to or higher than the glass transition point of the amorphous resin, in particular, “(the glass transition point of the amorphous resin+10° C.) to (the glass transition point of the amorphous resin+50° C.)”, and particularly preferably “(the glass transition point of the amorphous resin+15° C.) to (the glass transition point of the amorphous resin+40° C.)”.

### [Fluocculant]

The fluocculant used at this step is not particularly limited, but one selected from metal salts such as alkali metal salts and alkali earth metal salts is preferably used. Examples of the metal salts includes: monovalent metal salts such as sodium, potassium and lithium; divalent metal salts such as calcium, magnesium, manganese and copper; and trivalent metal salts such as iron and aluminum. Specific examples of the metal salts include sodium chloride, potassium chloride, lithium chloride, calcium chloride, magnesium chloride, zinc chloride, copper sulfate, magnesium sulfate and manganese sulfate. Among these, divalent metal salts are particularly preferably used because they can facilitate the agglomeration at a smaller amount. These may be used individually (one type) or in combination (two or more types).

In the case of the toner particles having a core-shell structure, for example, at this step, the amorphous resin particles, the crystalline polyester resin particles and the colorant particles are agglomerated and fused so as to form core particles, and thereafter the core particles and shell resin particles for forming the shell layer are agglomerated and fused so as to form toner particles.

### (e) Aging Step

This step is an optional step performed as needed. At this step, the associated particles produced at the agglomerating-fusing step are aged by thermal energy until the associated particles have a desired shape and accordingly toner particles are produced.

More specifically, the associated particles are aged by heating and stirring the system composed of the associated particles and adjusting the heating temperature, the stirring speed, the heating time and so forth until the particles have a desired circularity and accordingly toner particles are produced.

### (f) Cooling Step

At this step, the dispersion of the toner particles is cooled. The dispersion of the toner particles is preferably cooled at a cooling rate of 1 to 20° C./min as a cooling condition. A specific method for cooling the dispersion is not particularly limited, and examples thereof include a method of cooling the dispersion by introducing a coolant from the outside of a reaction vessel and a method of cooling the dispersion by pouring cold water directly in the reaction system.

### (g) Filtering-Washing Step

At this step, the toner particles are separated from the cooled dispersion of the toner particles (solid-liquid separation); from a toner cake (collection of the toner particles in the wet state agglomerated in the shape of a cake) produced by the solid-liquid separation, the attached substances such as the surfactant and the fluocculant are removed; and then the resulting product is washed.

The solid-liquid separation is not particularly limited, and usable examples thereof include: centrifugation; filtration under the reduced pressure with a Nutsche or the like; and filtration with a filter press or the like. Further, in the washing, it is preferable to perform water washing until electrical conductivity of the filtrate reaches 10 μS/cm.

### (h) Drying Step

At this step, the washed toner cake is dried. This step can be performed in accordance with a generally-performed drying step in a publically-known method for producing toner particles.

More specifically, a dryer used for drying the toner cake is exemplified by a spray dryer, a vacuum freeze dryer and a vacuum dryer, and it is preferable to use a stationary shelf dryer, a movable shelf dryer, a fluidized bed dryer, a rotary dryer, an agitated dryer or the like.

The moisture amount of the dried toner particles is preferably 5 percent by mass or less and far preferably 2 percent by mass or less. When the dried toner particles are agglomerated by weak interparticle attraction, the agglomerated body may be crushed. As a crusher, a mechanical crusher can be used, and examples thereof include a jet mill, a Henschel mixer, a coffee mill and a food processor.

### (i) Adding Step of External Additive

This step is an optional step performed as needed when an external additive(s) is added to the toner particles.

The above toner particles may be used as they are as the toner, but in order to improve fluidity, charge characteristics, cleanability and so forth, the toner particles may be used as the toner with an external additive(s) such as a fluidizing agent or a cleaning aid added.

As the external additive, various ones may be used in combination.

The total added amount of the external additive(s) is, to 100 parts by mass of the toner particles, preferably 0.05 to 5 parts by mass and far preferably 0.1 to 3 parts by mass.

As a mixer for mixing the external additive(s), a mechanical mixer can be used, and examples thereof include a Henschel mixer and a coffee mill.

In the above, the present invention is detailed with an embodiment. However, the present invention is not limited thereto, and various modifications can be made.

### Examples

Hereinafter, the present invention is detailed with Examples. However, the present invention is not limited thereto.

### Production Example 1 of Toner

### Example 1

### (1-1) Synthesis of Release Agent

Into a 5 L reaction vessel fitted with a stirring device, a temperature sensor, a cooling tube and a nitrogen introducing device, 170 parts by mass of behenic acid (molecular weight of 340.6) and 20 parts by mass of pentaerythritol (molecular weight of 136.2) were fed, and while this system was stirred, the internal temperature was increased to 210° C. taking one hour. After it was confirmed that the system was uniformly stirred (mixed), 0.05 percent by mass of sulfuric acid to the feed amount of the carboxylic acid was poured as a catalyst. Thereafter, while produced water was evaporated (removed), the internal temperature was increased from 210° C. to 240° C. taking six hours, and dehydration condensation reaction was continuously conducted at 240° C. for six hours so that polymerization reaction was conducted. Thus, a release agent [W1] of pentaerythritol tetrabehenic acid ester was produced.

In the release agent [W1], the content [Cm] of a carbon chain length component having the largest content was 80 percent by mass, and the melting point of the release agent [W1] was 83° C.

### (1-2) Preparation of Release Agent Particle Dispersion

200 parts by mass of the release agent [W1] was heated to 75° to melt. This was poured in a surfactant solution composed of sodium alkyl diphenyl ether disulfonate dissolved in 800 parts by mass of deionized water to be a concentration of 3 percent by mass, and dispersed therein with an ultrasonic homogenizer. The solid content concentration was adjusted to 20 percent by mass. Thus, a release agent particle dispersion [Wm1] of release agent particles dispersed in an aqueous medium was prepared.

The volume-based median diameter of the release agent particles in the release agent particle dispersion [Wm1] was measured with a Microtrac particle diameter analyzer UPA-150 (from Nikkiso Co., Ltd.), and it was 190 nm.

### (2-1) Synthesis of Amorphous Resin

Into a reaction vessel fitted with a stirring device, a nitrogen introducing tube, a temperature sensor and a rectifying column, 85 parts by mass of terephthalic acid, 6 parts by mass of trimellitic acid, 18 parts by mass of fumaric acid and 80 parts by mass of dodecenyl succinic anhydride as the polycarboxylic acid, and 381 parts by mass of propylene oxide adduct of bisphenol A and 62 parts by mass of ethylene oxide adduct of bisphenol A as the polyhydric alcohol were fed, and the temperature of the reaction system was increased to 190° C. taking one hour. After it was confirmed that the reaction system was uniformly stirred (mixed), 0.006 percent by mass of Ti(OBu)₄ to the total amount of the polycarboxylic acid was poured as a catalyst. Thereafter, while produced water was evaporated (removed), the temperature of the reaction system was increased from 190° C. to 240° C. taking six hours, and dehydration condensation reaction was continuously conducted at 240° C. for six hours so that polymerization reaction was conducted. Thus, an amorphous polyester resin [A1] was produced.

The number average molecular weight (Mn) of the amorphous polyester resin [A1] was 3,100, and the glass transition point thereof was 63° C. The molecular weight and the glass transition point of the amorphous resin were measured as described above.

The same applies to the following.

### (2-2) Preparation of Amorphous Polyester Resin Particle Dispersion

200 parts by mass of the amorphous polyester resin [A1] was dissolved in 200 parts by mass of ethyl acetate, and while this solution was stirred, an aqueous solution composed of sodium polyoxyethylene laurylether sulfate dissolved in 800 parts by mass of deionized water to be a concentration of 1 percent by mass was slowly dripped. Under the reduced pressure, ethyl acetate was removed from this solution, and then pH thereof was adjusted to 8.5 with ammonia. Thereafter, the solid content concentration was adjusted to 20 percent by mass. Thus, an amorphous polyester resin particle dispersion [Am1] of particles of an amorphous polyester resin [A1] dispersed in an aqueous medium was prepared.

The volume-based median diameter of the particles of the amorphous polyester resin [A1] was 230 nm.

### (3-1) Synthesis of Crystalline Polyester Resin

Into a reaction vessel fitted with a stirring device, a nitrogen introducing tube, a temperature sensor and a rectifying column, 200 parts by mass of tetradecanedioic acid as the polycarboxylic acid and 140 parts by mass of butanediol as the polyhydric alcohol were fed, and the temperature of the reaction system was increased to 190° C. taking one hour. After it was confirmed that the reaction system was uniformly stirred (mixed), 0.006 percent by mass of Ti (OBu)₄ to the total amount of the polycarboxylic acid was poured as a catalyst. Thereafter, while produced water was evaporated (removed), the temperature of the reaction system was increased from 190° C. to 240° C. taking six hours, and dehydration condensation reaction was continuously conducted at 240° C. for six hours so that polymerization reaction was conducted. Thus, a crystalline polyester resin [B1] was produced.

The number average molecular weight (Mn) of the crystalline polyester resin [B1] was 3,500, and the melting point thereof was 83° C. The molecular weight and the melting point of the crystalline polyester resin were measured as described above. The same applies to the following.

### (3-2) Preparation of Crystalline Polyester Resin Particle Dispersion

200 parts by mass of the crystalline polyester resin [B1] was dissolved in 200 parts by mass of ethyl acetate, and while this solution was stirred, an aqueous solution composed of sodium polyoxyethylene laurylether sulfate dissolved in 800 parts by mass of deionized water to be a concentration of 1 percent by mass was slowly dripped. Under the reduced pressure, ethyl acetate was removed from this solution, and then pH thereof was adjusted to 8.5 with ammonia. Thereafter, the solid content concentration was adjusted to 20 percent by mass. Thus, a crystalline polyester resin particle dispersion [Bm1] of particles of a crystalline polyester resin [B1] dispersed in an aqueous medium was prepared.

The volume-based median diameter of the particles of the crystalline polyester resin [B1] was 210 nm.

### (4) Preparation of Colorant Particle Dispersion

50 parts by mass of copper phthalocyanine (C.I. Pigment Blue 15:3) was poured in a surfactant solution composed of sodium alkyl diphenyl ether disulfonate dissolved in 200 parts by mass of deionized water to be a concentration of 1 percent by mass, and dispersed therein with an ultrasonic homogenizer. The solid content concentration was adjusted to 20 percent by mass. Thus, a colorant particle dispersion[1] of colorant particles dispersed in an aqueous medium was prepared.

The volume-based median diameter of the colorant particles in the colorant particle dispersion[1] was measured with a Microtrac particle diameter analyzer UPA-150 (from Nikkiso Co., Ltd.), and it was 150 nm.

### (5) Production of Toner Particles

70.8 parts by mass of the amorphous polyester resin particle dispersion [Am1], 86.4 parts by mass of the crystalline polyester resin particle dispersion [Bm1], 15.5 parts by mass of the release agent particle dispersion [Wm1], 58.5 parts by mass of the colorant particle dispersion [1], 45 parts by mass of deionized water and 0.5 parts by mass of sodium polyoxyethylene laurylether sulfate were poured into a reaction vessel fitted with a stirring device, a cooling tube and a temperature sensor (thermometer), and while this solution was stirred, 0.1N of a sodium hydroxide solution was added thereto to adjust pH to 10. Next, an aqueous solution composed of 11.6 parts by mass of magnesium chloride hexahydrate dissolved in 11.6 parts by mass of deionized water was dripped taking 10 minutes. While this solution was stirred, the internal temperature was increased to 60° C. At this point, sampling was conducted, and the particle diameter of the associated particles was measured with Multisizer 3 (from Beckman Coulter, Inc.). The volume-based median diameter thereof was 2.05 tm.

After the internal temperature was kept at 60° C. for one hour, a solution composed of (i) a mixed solution composed of 275.4 parts by mass of the amorphous polyester resin particle dispersion [Am1], 180 parts by mass of deionized water and 2 parts by mass of sodium polyoxyethylene laurylether sulfate and (ii) 0.1N of a sodium hydroxide solution added to the mixed solution so as to adjust pH to 5 was dripped taking one hour. The internal temperature was increased to 75° C. and kept thereat, and the particle diameter of the associated particles was measured with Multisizer 3 (from Beckman Coulter, Inc.). When the volume-based median diameter reached 5.3 vm, a sodium chloride solution composed of 15.8 parts by mass of sodium chloride dissolved in 63.3 parts by mass of deionized water was added to stop the particle growth. The internal temperature was increased to 85° C., and when the average circularity measured with FPIA-2100 (from Sysmex Co.) reached 0.964, the temperature was decreased to room temperature at 10 C/min.

### (6) Filtration, Washing and Drying

Next, a toner cake produced by solid-liquid separation and dehydration went through a process of re-dispersion in deionized water and solid-liquid separation three times and then washed, and thereafter dried at 40° C. for 24 hours. Thus, toner particles [1] were produced.

The volume-based median diameter of the toner particles [1] was 5.2 μm, and the average circularity thereof was 0.964. The particle diameter and the average circularity of the toner particles [1] were measured as described above. The same applies to the following.

### (7) Addition of External Additive

To 100 parts by mass of the produced toner particles [1], 0.6 parts by mass of hydrophobic silica particles (a number average primary particle diameter of 12 nm and a hydrophobicity of 68) and 1.0 parts by mass of hydrophobic titanium oxide particles (a number average primary particle diameter of 20 nm and a hydrophobicity of 63) were added and mixed therewith with a Henschel mixer (from Mitsui Miike Kakouki Kabushiki Kaisha) at a blade's peripheral speed of 35 mm/sec at 32° C. for 20 minutes, and then the resulting product was filtered through a mesh sieve having an opening of 45 vm to remove coarse particles (external additive treatment). Thus, a toner [1] was produced. Note that, in the toner [1], the shape and the particle diameter of the toner particles did not change by the addition of the external additives.

With respect to this toner [1], the melting peak point Tmc (° C.) derived from the crystalline polyester resin, the melting peak point Tmw (° C.) derived from the release agent and the glass transition point Tg (° C.) in the heating process in the differential scanning calorimetry of the toner were measured. The result is shown in TABLE 1.

### Production Example 2 of Toner

### Example 2

A toner [2] was produced in the same way as the toner [1] except that the polycarboxylic acid and the polyhydric alcohol in the “(3-1) Synthesis of Crystalline Polyester Resin” under the “Production Example 1 of Toner” were changed to succinic acid and 1,6-hexanediol, whereby a crystalline polyester resin [B2] was produced (synthesized) to use, and the release agent [W1] in the “(1-2) Preparation of Release Agent Particle Dispersion” under the “Production Example 1 of Toner” was changed to a release agent [W2] described below. The number average molecular weight (Mn) of the crystalline polyester resin [B2] was 4,000, and the melting point thereof was 81° C.

With respect to this toner [2], the melting peak point Tmc (° C.) derived from the crystalline polyester resin, the melting peak point Tmw (° C.) derived from the release agent and the glass transition point Tg (° C.) in the heating process in the differential scanning calorimetry of the toner were measured. The result is shown in TABLE 1.

### [Release Agent]

The release agent [2] was produced by dissolving a paraffin wax HNP-0190 (from Nippon Seiro Co., Ltd.) in n-hexane to re-crystallize.

In the release agent [W2], the content (Cm) of a carbon chain length component having the largest content was 8 percent by mass, and the melting point of the release agent [W2] was 83° C.

### Production Example 3 of Toner

### Example 3

### (1) Preparation of Aqueous Dispersion of Amorphous Resin Particles

### (First Stage Polymerization)

Into a 5 L reaction vessel fitted with a stirring device, a temperature sensor, a cooling tube and a nitrogen introducing device, a solution composed of 8 g of sodium dodecyl sulfate dissolved in 3 L of deionized water was fed, and while the solution was stirred at a stirring speed of 230 rpm under a nitrogen stream, the internal temperature was increased to 80° C. After the temperature increase, a solution composed of 10 g of potassium persulfate dissolved in 200 g of deionized water was added, the solution temperature was adjusted to 80° C. again, and a vinyl monomer solution composed of 480 g of styrene, 250 g of n-butyl acrylate and 68 g of methacrylic acid was dripped taking one hour. After the dripping, polymerization was conducted through heating and stirring at 80° C. for two hours. Thus, resin particles [a1] were produced.

### (Second Stage Polymerization)

Into a 5 L reaction vessel fitted with a stirring device, a temperature sensor, a cooling tube and a nitrogen introducing device, a solution composed of 7 g of polyoxyethylene-2-dodecyl ether sodium sulfate dissolved in 800 mL of deionized water was fed. After the solution was heated to 98° C., 260 g of the resin particles [a1] and a vinyl monomer solution composed of 284 g of styrene, 92 g of n-butyl acrylate and 13 g of methacrylic acid, 1.5 g of n-octyl-3-mercaptopropionate and 190 g of the release agent [W1] dissolved at 90° C. to be mixed were added, and mixed and dispersed for one hour with a dispersion machine having a circulation route CLEARMIX (from M Technique Co., Ltd.).

Thus, a dispersion containing emulsified particles (oil droplets) was prepared.

Next, to this dispersion, an initiator solution composed of 6 g of potassium persulfate dissolved in 200 mL of deionized water was added, and polymerization was conducted through heating and stirring of this system at 84° C. for one hour. Thus, resin particles [a2] were produced.

### (Third Stage Polymerization)

To the resin particles [a2], a solution composed of 11 g of potassium persulfate dissolved in 400 mL of deionized water was added, and under the temperature condition of 82° C., a mixed solution composed of (i) a vinyl monomer solution composed of 400 g of styrene, 128 g of n-butyl acrylate, 28 g of methacrylic acid and 45 g of methyl methacrylate and (ii) 8 g of n-octyl-3-mercaptopropionate was dripped taking one hour.

After the dripping, polymerization was conducted through heating and stirring for two hours, and then the temperature was decreased to 28° C. Thus, an aqueous dispersion [A2] of amorphous resin particles of a styrene-acrylic copolymer resin was prepared.

The volume-based median diameter of the amorphous resin particles was 220 nm, the weight average molecular weight (Mw) thereof was 25,000, and the glass transition point thereof was 50° C.

### (2-1) Synthesis of Crystalline Polyester Resin

Into a 5 L reaction vessel fitted with a stirring device, a temperature sensor, a cooling tube and a nitrogen introducing device, 300 parts by mass of tetradecanedioic acid as the polycarboxylic acid and 170 parts by mass of 1,6-hexanediol as the polyhydric alcohol were fed, and while this system was stirred, the internal temperature was increased to 190 C taking one hour. After it was confirmed that the system was uniformly stirred (mixed), 0.003 percent by mass of Ti(OBu)₄ to the feed amount of the polycarboxylic acid was poured as a catalyst. Thereafter, while produced water was evaporated (removed), the internal temperature was increased from 190° C. to 240° C. taking six hours, and dehydration condensation reaction was continuously conducted at 240° C. for six hours so that polymerization reaction was conducted. Thus, a crystalline polyester resin [B3] was produced.

The number average molecular weight (Mn) of the crystalline polyester resin [B3] was 3,900, and the melting point thereof was 76° C.

### (2-2) Preparation of Aqueous Dispersion of Crystalline Polyester Resin Particles

30 parts by mass of the crystalline polyester resin [B3] was made to melt, and the crystalline polyester resin [B3] in the melting state was transferred to an emulsion disperser Cavitron CD1010 (from Eurotech Co., Ltd.) at a transfer speed of 100 parts by mass per minute. At the same time as the transfer of the crystalline polyester resin [B3] in the melting state, diluted ammonia water having a concentration of 0.37 percent by mass composed of 70 parts by mass of reagent ammonia water diluted with water in an aqueous solvent tank was transferred to the emulsion disperser at a transfer speed of 0.1 L/min while heated to 100° C. with a heat exchanger. This emulsion disperser was driven under the conditions of a rotor's rotational speed of 60 Hz and a pressure of 5 kg/cm². Thus, an aqueous dispersion [Bm3] of crystalline polyester resin particles having a volume-based median diameter of 200 nm and a solid content of 30 parts by mass was prepared.

### (2-3) Preparation of Aqueous Dispersion of Composite Particles

Into a 5 L reaction vessel fitted with a stirring device, a temperature sensor, a cooling tube and a nitrogen introducing device, 2000 parts by mass of the crystalline polyester resin particle dispersion [Bm3] and 1150 parts by mass of deionized water were fed, a polymerization initiator solution composed of 10.3 parts by mass of potassium persulfate dissolved in 210 parts by mass of deionized water was added thereto, and under the temperature condition of 80° C., a monomer mixed solution composed of 390 parts by mass of styrene (St), 143 parts by mass of n-butyl acrylate (BA), 27 parts by mass of methacrylic acid (MAA) and 40 parts by mass of methyl methacrylate (MMA) was dripped taking two hours. After the dripping, seed polymerization was conducted through heating and stirring at 80° C. for two hours. After the polymerization finished, the temperature was decreased to 28° C. Thus, an aqueous dispersion [SB3] of composite particles [SB3] containing particles of a crystalline polyester resin [B3] was prepared.

The volume-based median diameter of the composite particles [SB3] in the aqueous dispersion [SB3] was 250 nm.

### (3) Preparation of Aqueous Dispersion [Bk] of Colorant Particles

90 parts by mass of sodium dodecyl sulfate was added to 1600 parts by mass of deionized water. While this solution was stirred, 420 parts by mass of carbon black REGAL 330R (from Cabot Co.) was gradually added, and subsequently dispersed with a dispersion machine CLEARMIX (from M Technique Co., Ltd.). Thus, an aqueous dispersion [Bk] of colorant particles was prepared.

The average particle diameter (volume-based median diameter) of the colorant particles in the produced aqueous dispersion [Bk] was 110 nm.

### (4) Preparation of Aqueous Dispersion [S1] of Shell Resin Particles

Into a 5 L reaction vessel fitted with a stirring device, a temperature sensor, a cooling tube and a nitrogen introducing device, 8 g of sodium dodecyl sulfate and 3 L of deionized water were fed, and while the solution was stirred at a stirring speed of 230 rpm under a nitrogen stream, the internal temperature was increased to 80° C. After the temperature increase, a solution composed of 10 g of potassium persulfate dissolved in 200 g of deionized water was added, the solution temperature was adjusted to 80° C. again, and a monomer mixed solution composed of 480 g of styrene, 250 g of n-butyl acrylate, 68 g of methacrylic acid and 0.5 g of n-octyl-3-mercaptopropionate was dripped taking one hour. After the dripping, polymerization was conducted through heating and stirring at 80° C. for two hours. Thus, an aqueous dispersion [S1] of shell resin particles was prepared.

The volume-based median diameter of the shell resin particles was 100 nm, the weight average molecular weight (Mw) thereof was 28,000, and the glass transition point thereof was 60° C.

### (5) Production of Toner Particles

Into a zebra flask fitted with a stirring device, a temperature sensor, a cooling tube and a nitrogen introducing device, the aqueous dispersion [A2] in which 600 parts by mass of the amorphous resin particles were dispersed, 90 parts by mass (in terms of a solid content) of the aqueous dispersion [SB3] of the composite particles [SB3] containing the crystalline polyester resin particles [B3], 2500 parts by mass of deionized water and 500 parts by mass of the aqueous dispersion [Bk] of the colorant particles were fed, the solution temperature was adjusted to 25° C., and then a sodium hydroxide solution having a concentration of 25 percent by mass was added thereto to adjust pH to 10.

Next, a solution composed of 54.3 parts by mass of magnesium chloride hexahydrate dissolved in 54.3 parts by mass of deionized water was added thereto, and thereafter the temperature of the system was increased to 97° C. so that agglomeration reaction of the resin particles and the colorant particles started.

After this agglomeration reaction started, sampling was regularly conducted, and the volume-based median diameter of the colorant particles was measured with a particle size distribution measuring device Multisizer 3 (from Beckman Coulter, Inc.). Until the volume-based median diameter reached 6.3 μm, stirring was continued for the agglomeration.

Next, an aqueous solution composed of 11.5 parts by mass of sodium chloride dissolved in 46 parts by mass of deionized water was added, and the aqueous dispersion [S1] in which 10 parts by mass of the shell resin particles were dispersed was added thereto, whereby the shell resin particles were attached to the surface of the core particles.

Thereafter, an aqueous solution composed of 11.5 parts by mass of sodium chloride dissolved in 46 parts by mass of deionized water was added, the temperature of the system was adjusted to 95° C., and the stirring was continued for four hours. When the circularity measured with a flow particle image analyzer FPIA-2100 (from Sysmex Co.) reached 0.946, the temperature was decreased to 30° C. at 6° C./min to stop the reaction. Thus, a dispersion of toner particles was prepared. The particle diameter of the cooled toner particles was 6.1 μm, and the circularity thereof was 0.946.

The dispersion of the toner particles thus-produced was subjected to solid-liquid separation with a basket-type centrifugal separator MARK III, type No. 60×40 (from Matsumoto Machine Mfg. Co., Ltd.) to form a wet cake. The wet cake was repeatedly subjected to washing and solid-liquid separation with the basket-type centrifugal separator until electric conductivity of the filtrate reached 15 μS/cm, and then dried with Flash Jet Dryer (from Seishin Enterprise Co., Ltd.) by blowing air having a temperature of 40° C. and a humidity of 20% RH thereto until the moisture content reached 0.5 percent by mass, and cooled to 24° C. Thus, toner particles [3] were produced. The volume-based median diameter of the toner particles [3] was 6.1 μm, and the average circularity thereof was 0.946.

### (6) Addition of External Additive

To the produced toner particles [3], 1 percent by mass of hydrophobic silica particles and 1.2 percent by mass of hydrophobic titanium oxide particles were added and mixed therewith with a Henschel mixer at a blade's peripheral speed of 24 m/sec for 20 minutes, and then the resulting product was filtered through a 400 mesh sieve, whereby the external additives were added. Thus, a toner [3] was produced. Note that, in the toner [3], the shape and the particle diameter of the toner particles did not change by the addition of the external additives.

With respect to this toner [3], the melting peak point Tmc (° C.) derived from the crystalline polyester resin, the melting peak point Tmw (° C.) derived from the release agent and the glass transition point Tg (° C.) in the heating process in the differential scanning calorimetry of the toner were measured. The result is shown in TABLE 1.

### Production Example 4 of Toner

### Example 4

A toner [4] was produced in the same way as the toner [3] except that the polycarboxylic acid and the polyhydric alcohol in the “(2-1) Synthesis of Crystalline Polyester Resin” under the “Production Example 3 of Toner” were changed to dodecanedioic acid and ethylene glycol, whereby an aqueous dispersion [SB4] of composite particles [SB4] containing particles of a crystalline polyester resin [B4] was prepared to use, and the release agent [W1] in the “(1) Preparation of Aqueous Dispersion of Amorphous Resin Particles” under the “Production Example 3 of Toner” was changed to the release agent [W2]. The number average molecular weight (Mn) of the crystalline polyester resin [B4] was 4,100, and the melting point thereof was 83° C.

With respect to this toner [4], the melting peak point Tmc (° C.) derived from the crystalline polyester resin, the melting peak point Tmw (° C.) derived from the release agent and the glass transition point Tg (° C.) in the heating process in the differential scanning calorimetry of the toner were measured. The result is shown in TABLE 1.

### Production Example 5 of Toner

### Comparative Example 1

A toner [5] was produced in the same way as the toner [2] except that the release agent [W2] in the “(1-2) Preparation of Release Agent Particle Dispersion” under the “Production Example 2 of Toner” was changed to a release agent [W3] described below.

With respect to this toner [5], the melting peak point Tmc (° C.) derived from the crystalline polyester resin, the melting peak point Tmw (° C.) derived from the release agent and the glass transition point Tg (° C.) in the heating process in the differential scanning calorimetry of the toner were measured. The result is shown in TABLE 1.

### [Synthesis of Release Agent]

Into a 5 L reaction vessel fitted with a stirring device, a temperature sensor, a cooling tube and a nitrogen introducing device, 90 parts by mass of behenic acid (molecular weight of 340.6), 80 parts by mass of stearic acid (molecular weight of 284.48), 85 parts by mass of behenyl alcohol (molecular weight of 326.6) and 80 parts by mass of stearyl alcohol (molecular weight of 270.49) were fed, and while this system was stirred, the internal temperature was increased to 190° C. taking one hour. After it was confirmed that the system was uniformly stirred (mixed), 0.05 percent by mass of sulfuric acid to the feed amount of the carboxylic acid was poured as a catalyst. Thereafter, while produced water was evaporated (removed), the internal temperature was increased from 190° C. to 240° C. taking six hours, and dehydration condensation reaction was continuously conducted at 240° C. for six hours so that polymerization reaction was conducted. Thus, a release agent [W3] in which a carbon chain length component having the longest carbon chain length was behenyl behenate was produced.

In the release agent [W3], the content [Cm] of a carbon chain length component having the largest content was 57 percent by mass, and the melting point of the release agent [W3] was 66° C.

### Production Example 6 of Toner

### Comparative Example 2

A toner [6] was produced in the same way as the toner [3] except that the release agent [W1] in the “(1) Preparation of Aqueous Dispersion of Amorphous Resin Particles” under the “Production Example 3 of Toner” was changed to a release agent [W4] described below, and the polycarboxylic acid and the polyhydric alcohol in the “(2-1) Synthesis of Crystalline Polyester Resin” under the “Production Example 3 of Toner” were changed to dodecanedioic acid and 1,9-nonanediol, whereby an aqueous dispersion [SB5] of composite particles [SB5] containing particles of a crystalline polyester resin [B5] was prepared to use. The number average molecular weight (Mn) of the crystalline polyester resin [B5] was 3,900, and the melting point thereof was 65° C.

With respect to this toner [6], the melting peak point Tmc (° C.) derived from the crystalline polyester resin, the melting peak point Tmw (° C.) derived from the release agent and the glass transition point Tg (° C.) in the heating process in the differential scanning calorimetry of the toner were measured. The result is shown in TABLE 1.

### [Release Agent]

A paraffin wax HNP-0190 (from Nippon Seiro Co., Ltd.) was used as the release agent [W4].

In the release agent [W4], the content (Cm) of a carbon chain length component having the largest content was 4 percent by mass, and the melting point of the release agent [W4] was 82° C.

TABLE 1

| | | | RELEASE AGENT | | | |
|---|---|---|---|---|---|---|
| | | | | | CARBON CHAIN | |
| | | | | | LENGTH OR | |
| | | | | | CARBON NUMBER OF | |
| | | | | | CARBON CHAIN LENGTH | [Cm] |
| TONER | AMORPHOUS RESIN | | | | COMPONENT HAVING | (percent |
| No. | No. | TYPE | No. | TYPE | LARGEST CONTENT | by mass) |
| TONER | [A1] | AMORPHOUS | [W1] | TETRAESTER | C98 | 80 |
| [1] | | POLYESTER RESIN | | | | |
| TONER | [A1] | AMORPHOUS | [W2] | PARAFFIN | C48 | 8 |
| [2] | | POLYESTER RESIN | | | | |
| TONER | [A2] | STYRENE-ACRYLIC | [W1] | TETRAESTER | C98 | 80 |
| [3] | | COPOLYMER RESIN | | | | |
| TONER | [A2] | STYRENE-ACRYLIC | [W2] | PARAFFIN | C48 | 8 |
| [4] | | COPOLYMER RESIN | | | | |
| TONER | [A1] | AMORPHOUS | [W3] | MONOESTER | C22/C22 | 57 |
| [5] | | POLYESTER RESIN | | | | |
| TONER | [A2] | STYRENE-ACRYLIC | [W4] | PARAFFIN | C48 | 4 |
| [6] | | COPOLYMER RESIN | | | | |

| | CRYSTALLINE POLYESTER RESIN | | | | | | |
|---|---|---|---|---|---|---|---|
| TONER | | POLYCARBOXYLIC | POLYHYDRIC | Tmw | Tmc | \|Tmw − Tmc\| | Tg |
| No. | No. | ACID | ALCOHOL | (° C.) | (° C.) | (° C.) | (° C.) |
| TONER | [B1] | TETRADECANEDIOIC | BUTANEDIOL | 85 | 83 | 2 | 50 |
| [1] | | ACID | | | | | |
| TONER | [B2] | SUCCINIC ACID | 1,6-HEXANEDIOL | 82 | 81 | 1 | 50 |
| [2] | | | | | | | |
| TONER | [B3] | TETRADECANEDIOIC | 1,6-HEXANEDIOL | 85 | 76 | 9 | 45 |
| [3] | | ACID | | | | | |
| TONER | [B4] | DODECANEDIOIC | ETHYLENE | 82 | 83 | 1 | 45 |
| [4] | | ACID | GLYCOL | | | | |
| TONER | [B2] | SUCCINIC ACID | 1,6-HEXANEDIOL | 66 | 81 | 15 | 50 |
| [5] | | | | | | | |
| TONER | [B5] | DODECANEDIOIC | 1,9-NONANEDIOL | 81 | 65 | 16 | 45 |
| [6] | | ACID | | | | | |

### Production Examples 1 to 6 of Developers

To each of the toners [1] to [6], ferrite carriers which coated a silicone resin and had a volume-based median diameter of 60 am was added so as to be a toner concentration of 6 percent by mass, and mixed therewith with a V-type mixer. Thus, developers [1] to [6] were produced.

### (1) Evaluation of Low-Temperature Fixability

For evaluation of low-temperature fixability, as an image evaluation device, there was used a commercially-available copier bizhub PRO C6500 (from Konica Minolta, Inc.) modified in such a way that the surface temperature (measured at the center part of a roller) of a heat-fixing roller was changeable in a range from 100° C. to 200° C. Into this image evaluation device, each of the developers [1] to [6] was put, and under the room temperature and normal humidity (a temperature of 20° C. and a humidity of 50% RH), a fixing test to fix a solid image having a toner-deposited amount of 8 mg/cm² to A4 high-quality paper was repeatedly conducted while the set fixing temperature was increased in 5° C. segments from 120° C. up to 200° C. Among the fixing temperatures at which image stains due to cold offset were not visually observed, the lowest temperature was evaluated as the lowest fixing temperature. When the lowest fixing temperature was 150° C. or lower, the toner was regarded as passing the text. The result is shown in TABLE 2.

(2) Evaluation of Separability from Fixing Member

The image evaluation device used for evaluation of low-temperature fixability was also used for evaluation of separability from a fixing member. For evaluation of separability from a fixing member, the surface temperature of the heat-fixing of the device was set at 160° C., and A4 paper having a belt-shaped solid black image having a width of 5 cm in a direction perpendicular to a paper conveyance direction was carried in longitudinal feed. The separability of the paper on the image side from the heat-fixing roller was evaluated according to the following evaluation criteria. The result is shown in TABLE 2. In the present invention, when the evaluation result was A or B, the toner was regarded as passing the test.

### —Evaluation Criteria—

A: paper is not curled and separates from the heat-fixing roller

B: paper separates from the heat-fixing roller, but the front end thereof is slightly curled (no problem in practical use)

C: (i) paper separates from the heat-fixing roller, but gloss non-uniformity is seen on the image surface, or (ii) paper is wound around the heat-fixing roller and cannot separate from the heat-fixing roller

### (3) Evaluation of Document Offset Resistance

The image evaluation device used for evaluation of low-temperature fixability was equipped with an exclusive-use finisher FS-608 (from Konica Minolta, Inc.), and an automatic binding test to create 20 sets (each set composed of five sheets) by saddle stitching printing was repeated 50 times. A pixel rate per page was set at 50%. As image supports, paper having a basis weight of 64 g/m² was used. The printed matters were naturally cooled to room temperature. Thereafter, all the pages (sheets) of each set were turned over by one hand, and whether or not the images adhered to each other was checked and evaluated according to the following criteria. The result is shown in TABLE 2.

### —Evaluation Criteria—

Excellent: no adhesion of images, and no funny feeling in turning over pages

Good: slight friction in turning over superposed pages, but no adhesion of images

Bad: adhesion of images in turning over superposed pages

TABLE 2

| | | LOW- | | |
|---|---|---|---|---|
| | | TEMPERATURE | SEPARA- | DOCU- |
| | | FIXABILITY | BILITY | MENT |
| | | LOWEST FIXING | FROM | OFFSET |
| | TONER | TEMPERATURE | FIXING | RESIS- |
| | No. | (° C.) | MEMBER | TANCE |
| EXAMPLE 1 | TONER | 130 | B | EXCEL- |
| | [1] | | | LENT |
| EXAMPLE 2 | TONER | 145 | A | GOOD |
| | [2] | | | |
| EXAMPLE 3 | TONER | 125 | B | GOOD |
| | [3] | | | |
| EXAMPLE 4 | TONER | 150 | A | GOOD |
| | [4] | | | |
| COMPARATIVE | TONER | 155 | B | GOOD |
| EXAMPLE 1 | [5] | | | |
| COMPARATIVE | TONER | 135 | C | BAD |
| EXAMPLE 2 | [6] | | | |

This application is based upon and claims the benefit of priority under 35 U.S.C. 119 of Japanese Patent Application No. 2014-126202 filed Jun. 19, 2014, the entire disclosure of which, including the specification, claims and abstract, is incorporated herein by reference in its entirety.

What is claimed is:

1. A toner for developing an electrostatic image, the toner comprising a toner particle containing a binder resin and a release agent, wherein
the binder resin contains an amorphous resin and a crystalline polyester resin, and
the toner satisfies the following formulae (1) and (2):
Tmc>75(° C.); and Formula (1)

|Tmw−Tmc|<10(° C.) Formula (2)
wherein Tmc (° C.) represents a melting peak temperature derived from the crystalline polyester resin and Tmw (° C.) represents a melting peak temperature derived from the release agent in a heating process in differential scanning calorimetry of the toner.

2. The toner according to claim 1, wherein the Tmc is higher than 80° C.

3. The toner according to claim 1, wherein the toner satisfies the following formula (3):
Tmw≧Tmc>Tg, Formula (3)
wherein Tg (° C.) represents a glass transition point of the toner.

4. The toner according to claim 1, wherein
the release agent is composed of at least an ester-based wax,
the release agent is composed of a plurality of carbon chain length components having different carbon chain lengths, and
among the carbon chain length components, a content of a carbon chain length component having the largest content in a carbon chain length distribution of the release agent is 70 percent by mass or more.

5. The toner according to claim 4, wherein the content of the carbon chain length component having the largest content is 80 percent by mass or more.

6. The toner according to claim 1, wherein
the release agent is composed of at least a hydrocarbon-based wax,
the release agent is composed of a plurality of carbon chain length components having different carbon chain lengths, and
among the carbon chain length components, a content of a carbon chain length component having the largest content in a carbon chain length distribution of the release agent is 5 percent by mass or more.

7. The toner according to claim 6, wherein the content of the carbon chain length component having the largest content is 7 percent by mass or more.
